(19) United States
(12) Patent Application Publication
(10) Pub. No.: US 2016/0312322 A1
(43) Pub. Date: Oct. 27, 2016

(54) DEVICE AND METHOD FOR TREATING METALLIC MATERIALS

(71) Applicant: ALD VACUUM TECHNOLOGIES GMBH, Hanau (DE)

(72) Inventors: Hans Johann KEMMER, Rödermark (DE); Christian LEHNERT, Bad Vilbel (DE); Andreas EICH, Alzenau (DE); Harald SCHOLZ, Rodenbach (DE); Peter ZOTZ, Freigericht (DE)

(21) Appl. No.: 15/105,362

(22) PCT Filed: Dec. 16, 2014
(86) PCT No.: PCT/EP2014/078063

§ 371 Date: Jun. 16, 2016

(30) Foreign Application Priority Data
Dec. 23, 2013 (DE) 10 2013 114 811.5

(51) Int. Cl. C21C 5/02; F27D 11/06; C21C 5/52; F27B 14/04; C21C 5/28; H05B 6/26; F27B 14/06

(52) U.S. Cl. CPC C21C 5/02; H05B 6/26; F27D 11/06; F27B 14/061; F27B 14/04; C21C 5/285; C21C 5/5241; C21C 5/5294; F27B 2014/045; F27B 2014/002

(57) ABSTRACT

A device and a method for treating metallic material. In particular, the invention is suitable for treating and/or producing steel and metallic alloys, in particular non-standard grade steels and alloys of particularly high quality. The invention has proved to be particularly successful in the treatment of iron-based metallic materials.

### FIELD OF THE INVENTION

The present invention relates to a device and a method for treating metallic material. In particular, the invention is suitable for treating and/or producing steel and metallic alloys, in particular non-standard grade steels and alloys of particularly high quality. The invention has proved to be particularly successful in the treatment of iron-based metallic materials.

### BACKGROUND OF INVENTION

The production of many grades of steel requires multistep melting processes. Nearly all melting furnaces known from prior art are equipped with stationary melting vessels. The transport of the liquid melt between the treatment stations is achieved by means of tilting hoppers. According to prior art, at first from the melting furnace a liquid melt is poured into a transport hopper. From this transport hopper, after a change of location by means of a crane, the melt is in turn poured off into the further treatment furnace. Most often several hoppers are used. This invention allows such working without the use of such hoppers. This is connected with economic advantages.

Furthermore, the present invention provides the following advantages: elimination of temperature problems and heat losses which normally occur during the transport of the melt, when such a hopper system (=a plurality of hoppers for transporting liquid metal made of refractory materials and their heating devices, etc.) is used. When such a hopper system is used, then this results in relatively long transport times between the melting units. The hoppers used are not heated. Partially, the melt is treated in the hoppers by means of additional stationary heating units. Due to the long transport times and the repeated transfers of the melts into other vessels the melts quickly cool down and even may solidify in the case of pouring off, when the treatment times have to be extended for adjusting certain gas contents or purity degrees. The heat losses in the facility according to the present invention are substantially lower, especially due to very short transport times and the only one transfer action. Therefore, with this invention problems in connection with the temperature control, when liquid melt is transferred from a melting unit into the further treatment furnace, can efficiently be avoided.

In conventional methods cross contaminations may occur. When residual melt remains in the tilting hoppers, then for follow-up melts this may result in contamination of the material. With the present invention this problem can be avoided to a great extent.

With the help of the present invention new process ways can be realized. The hopper system can only be used in the case of large batches. Then most often the heat content of the melt is high enough, so that the melt does not solidify in the non-heated hoppers. However, in the case of small amounts of melt the heat content is low and the melt solidifies quickly. Due to the substantially lower heat loss during transport and the very short transport times the present invention also allows the efficient processing of smaller amounts of melt.

The facility according to the present invention and the method according to the present invention result in maximum flexibility. The melting vessel can be used in the whole steel plant for receiving feedstocks and for further functions. With quick transport procedures the productivity of the plant can be improved. A melting furnace and a further treatment furnace can be clocked very well. Melting vessels can be charged beyond the melting position and can quickly be replaced by emptied melting vessels for increasing the productivity.

The method according to the present invention and the facility according to the present invention provide increased safety. Hoppers and also vessels mentioned in prior art documents are most often transported with the help of a crane. During the transport no observation of the melting receptacle takes place. With respect to safety aspects such a transport needs to be optimized. This invention allows a safe transport of the whole vessel on a railing system and at the same time an observation of the condition of the real melting receptacle and it also allows avoiding of a reallocation and of a transport by means of a crane.

The transport of the whole vessel becomes possible. With the present invention the inconvenient insertion of the melting receptacle into a heating facility is no longer necessary. Damages of the components which may be the result of an inappropriate insertion are avoided. Thus, the safety is increased strongly.

In conventional methods and devices the hopper most often comprises a thicker refractory outer masonry and bearing structure. Therefore, the heating facility most often is locally arranged further away than an induction coil which is located in the vessel. So the efficiency factor of heating is increased.

A significant difference in relation to prior art is that the melting vessel according to the present invention itself comprises a heating device and that it can be moved in a ridable manner by means of a transport facility. In prior art EP 0 212 072 A2, for example, for maintenance purposes also the melting vessel can be removed from the cover and the melting vessel also comprises the coil and it can be placed on a transport vehicle, but the melting vessel is not suitable or intended for transporting the melt, because the heating of the melt is only possible by the realization of a flange connection with the cover. A connection via a quick-coupling system for energy and cooling water is not provided. Thus, during the transport the vessel cannot be cooled and/or the temperature of the vessel cannot be maintained.

The teaching of WO 03/047792 A1 is contrary to the teaching of the present invention, because it is recommended against a vessel comprising a heating facility and a cooling facility. Instead of that a receptacle is provided which can be used as both, as a transport receptacle and as a receptacle for maintaining the temperature, degassing and pouring. However, the molten material should be removed with a scoop, which is extremely inefficient. During some process steps the melt remains in the receptacle so that frequent transfers are avoided. In the case of processing aluminum this is particularly important with respect to oxide formation. However, the magnetic coil for heating the melt is located in a stationary heating unit and not at the mobile melting vessel. The receptacle does not comprise a heating facility, but it is put onto a stationary heating unit for heating.

DE 2 035 221 B teaches a facility for maintaining the temperature of metallic melts. But also here the heating facility has a stationary design. Into the heating facility a tilting hopper can be inserted. The maintenance of the temperature of the melt requires an inconvenient working step, because the tilting hopper has to be moved into the position for maintaining the temperature. The tilting hopper itself does not comprise any heating facility.

DE 1 508 112 A relates to a method and an arrangement for treating metal melts. The crucible used can be placed on a vehicle. Then it can be moved between heating and evacuation facilities. But the heating facility comprising electrodes is fixed at the cover and thus it is not a part of the vessel. In fact, the crucible also comprises a coil for stirring the melt, but this coil is not suitable for heating. And the stirrer in fact results in maintaining the temperature in a certain extent, but the power thereof is not high enough for effectively warming or even heating the melt. In addition, no quick-coupling system is provided for heating the melting vessel in the treatment station. A considerable disadvantage of the facility just described is that the crucible cannot be vacuum-treated and heated at only one station.

Thus, there is a need for providing a device and a method for treating metallic material with which several process steps can be conducted in one single receptacle without the requirement of inconvenient placement of the receptacle in heating facilities or vacuum cambers. It is the object of this invention to provide a facility and a method with which several steps of metal treatment can be conducted in one melting vessel without the requirement of inconvenient transfers in tilting hoppers.

As a result of this also complex steels and alloys can be treated with oxygen-affine alloy additives for which during the whole melting, treating and pouring off phase it is necessary that the melt remains under exclusion of air (vacuum) for avoiding reoxidation of the oxygen-affine elements.

The object is solved by the subject matter of the patent claims.

### SUMMARY OF THE INVENTION

This invention relates to a device for treating metallic material, comprising one or more mobile melting vessels and at least one treatment station, wherein the mobile melting vessel comprises a crucible, a heating induction facility with an induction coil and a housing, the treatment station comprises a cover which is suitable for gas-tightly closing the crucible, and the mobile melting vessel, preferably automatically, can be separated from and coupled to the treatment station and can be moved in a ridable manner independently from the treatment station, characterized in that the device comprises a preferably automatic quick-coupling system so that (preferably all) current and media supply connections of the treatment station can be connected to the mobile melting vessel for cooling the heating induction facility and for supplying it with electricity, a transport facility is provided which is suitable for moving the melting vessel out of the area of the treatment station, means at or in the transport facility and/or the mobile melting vessel are provided for cooling the heating induction facility during the movement of the melting vessel and for supplying it with electricity.

Thus, the device of this invention combines a series of advantages. As a result of the fact that the melting vessel is designed in a mobile manner it is no longer necessary to transfer the metallic material for different treatment steps. The use of tilting hoppers is no longer necessary. In addition, the facility according to the present invention combines the melting and vacuum treatment in one single treatment station. The heating facility which is necessary for melting is located in the melting vessel; the treatment station in turn comprises a cover which is capable of gas-tightly closing the crucible. So it is possible to evacuate the crucible after coupling it to the treatment station. So it is no longer necessary to move the crucible between a melting station and a vacuum treatment station in a ridable manner. In addition, the heating facility which is a part of the melting vessel offers the possibility of heating the content of the crucible during the transport so that a melt which is located in the crucible does not solidify. If several treatment stations are provided, then it is possible that the distances between them are longer.

Preferably, the transport facility and/or the melting vessel comprise a cooling unit for cooling the induction coil during the transport. Induction coils for heating have to be cooled. Dependent on the power of the heating induction device it is necessary to dissipate more or less heat again. Therefore, it is preferable to provide an auxiliary cooling unit which cools the coil during the transport. The auxiliary cooling unit may be arranged at the melting vessel. But preferably, it is arranged at the transport facility so that during tilting of the melting vessel it is not necessary to also lift up this auxiliary cooling unit.

The transport facility may be a towing vehicle. It is possible that the towing vehicle is moved for example on rails. When a melting vessel should be removed from the treatment station, then the towing vehicle is connected with the melting vessel. Necessary connections which guarantee the supply of the melting vessel with electricity and/or coolant are also preferably provided. In such an embodiment the mobile melting vessel preferably comprises wheels so that it can be pulled on the rails from the towing vehicle.

The heating induction facility, at least after coupling to the treatment station, is preferably capable of maintaining metallic material which is located in the crucible in a molten state and/or melting it. The power of the heating facility of the melting vessel is so high that metallic material can be melted with respective current supply. In the coupled condition the current supply is realized via the treatment station. Preferably, the heating facility has a power in the range of at least 1 MW to 7 MW, particularly preferably of 3 MW to 6 MW. In the uncoupled condition, when the current supply is not guaranteed via the treatment station, the heating facility can be operated via the current supply of the transport facility or the melting vessel having a power of 100 kW to <1 MW, preferably of 300 kW to 700 kW. This power is high enough for avoiding the solidification of the melt during a transport.

Preferably, the treatment station comprises a tilting facility for pouring off a melt of the metallic material. The treatment station serves for treating the metallic material. In this treating step different treatment steps may be subsumed. The metallic material may be melted in the melting vessel at the treatment station. Below, further treatment steps are explained in more detail.

The melting vessel comprises a crucible. Preferably, the crucible is surrounded by the heating facility in the form of an induction coil. In addition, the melting vessel is equipped with a preferably gas-tight housing consisting preferably of metal. The melting vessel and also its constituents are designed for operation under vacuum. So that the induction heater can be operated, preferably a cooling system is provided for the induction coil. The cooling system in particular comprises lines for a cooling medium. Preferably, the lines are arranged in the melting vessel near the induction coil for guaranteeing an effective cooling. In a preferable embodiment the melting vessel can be connected with the transport facility in a detachable manner.

The metallic material which is preferably treated in the mobile furnace module comprises metals and metal alloys. Particularly preferable metallic materials are steels, in particular highly alloyed steels. Preferably, the metallic material is not aluminum, magnesium or an alloy with aluminum or magnesium as main constituent (>50% by weight), because for such materials particular devices would be required. The metallic material to be treated according to the present invention preferably comprises at least one of the metals copper, iron, cobalt, chromium and nickel in a mass proportion of at least 30%, further preferably 40% and particularly preferably 50%. Highly alloyed steels such as produced according to the present invention preferably using the described method have to be treated under vacuum.

The induction coil which is a constituent of the heating facility is arranged in the melting vessel outside the crucible. For preventing damages, it is very important that it is cooled, when a liquid is contained in the melting vessel. The crucial point is that the melt in the crucible can be maintained warm during the transport by means of the heating facility. For this purpose also the cooling system is preferably a constituent of the melting vessel and/or the transport facility. Preferably, the cooling system may comprise lines for cooling medium, a reservoir for cooling medium, at least one pump, at least one evaporator and/or at least one compressor.

Due to the fact that the melting vessel comprises both, a heating facility and a cooling system, it becomes possible to maintain a melt in the liquid state for further treatment steps. It is no longer necessary to provide an external heating facility for the melt. In particular, it is not necessary to move the melt from one treatment station for heating to another treatment station for further treatment. According to the present invention the melt can be heated in the mobile melting vessel and can be left in the melting vessel for a further treatment step. Also in the case, when the further treatment step is conducted delayed in time, there is no risk that the melt solidifies. According to the present invention the melting vessel can preferably stay at the treatment station for conducting several treatment steps.

In the simplest and thus preferable embodiment the cooling medium is water. Preferably, the cooling system comprises a reservoir for the cooling medium. Preferably, the reservoir is implemented such that it is a constituent of the transport facility. The reason for that is that the melting vessel is preferably designed such that it can be detached from the transport facility. One reason for the detachability of the melting vessel from the transport facility among others is that the melt can be poured off from the melting vessel without the need of lifting up the transport facility. It seems to make sense, when the reservoir for the cooling medium due to its weight is implemented as a part of the transport facility. Also preferably present pumps, evaporators and/or compressors are preferably arranged at or in the transport facility.

Preferably, the transport facility and/or the melting vessel comprise a current supply which is suitable for supplying the heating facility and the cooling system with the required energy for their operation during the transport of the melting vessel. Preferably, the current supply is implemented as a part of the transport facility. Typically, the power of the current supply which is required during the transport for the operation of the heating facility and the cooling system is lower than the power of the current supply which supplies the heating facility in the coupled condition. The current supply of the transport facility and/or the melting vessel may be a generator, in particular a diesel generator. But it is also possible to guarantee the current supply with the help of batteries.

As described above, preferably, the melting vessel can be detached from the transport facility. So it becomes possible, to tilt the melting vessel for pouring off the melt. It is clear that with the separation of the melting vessel from the transport facility a connection of lines for the cooling medium has to be separated. The same applies to the current supply.

For guaranteeing an as interruption-free as possible supply of the melting vessel with the media which are necessary for its operation, for the connection of the respective media lines (current supply lines, water, inert gas, data cable, . . . ) a (preferably automatic) quick coupling between the melting vessel and the treatment station is provided. This quick coupling allows the quick, simple and safe connection and separation of the melting vessel and the treatment station. The quick coupling is necessary for preventing damages of the coil which may be generated by conduction of heat from the melt.

Preferably, the quick coupling comprises three components, in particular an acceptor module on the acceptor side (at the melting vessel), a supply module on the supply side and a receiving and lifting unit. The supply module may be a constituent of the treatment station. The acceptor module is preferably a constituent of the melting vessel. The supply module is connected with the main current supply and the main coolant supply. Preferably, the supply module and the acceptor module can be coupled and uncoupled quickly and automatically, in particular by lifting up the supply module to the acceptor module.

The supply module can be automatically coupled to and uncoupled from the receiving and lifting unit. It serves for resting the supply unit during the transport of the mobile melting vessel and for its positioning (lifting up and lowering down) during the coupling procedure of the supply and acceptor sides. During the transport of the melting vessel the supply module and the receiving unit are preferably coupled with each other and are preferably rested on a platform near the treatment station. Preferably, the acceptor module is fixed on the mobile melting vessel. In the coupled condition the acceptor and supply sides are coupled with each other and the receiving and lifting unit is rested near the treatment station.

The acceptor module and the supply module are preferably designed such that a safe connection can be realized, wherein in particular it may be possible to provide openings at one of the modules which are suitable for receiving connection elements of the other module. Then, the connection elements are formed such that they can be inserted into the openings. The openings may be provided at the acceptor module or the supply module. Then, a plug connection becomes possible which can be automatically realized by lifting up or lowering down the acceptor module or the supply module. In the case of the current supply the connection elements may be implemented as contact pins, and in the case of the cooling medium and/or the inert gas feed they may be implemented as line ends.

Each melting vessel preferably comprises one acceptor module. Thus, several melting vessels can freely be used and can be exchanged among each other. But only one supply module and one set of flexible electric cables are required stationary at the treatment station.

After uncoupling of supply and acceptor side the mobile melting vessel is automatically coupled to the transport facility with its own drive and cooling unit, and can then be moved in a flexible manner.

The pouring off of the melt from the melting vessel is preferably achieved by tilting the melting vessel in the treatment station. For this purpose the melting vessel preferably comprises an outlet, preferably in the form of an outflow (e.g. casting tube or spout).

Because of the fact that in the case of releasing the connection between the melting vessel and the transport facility the media lines, in particular lines for the cooling medium and the current supply, are separated, at this treatment station respective media connections between the treatment station and the melting vessel are provided.

The melting vessel comprises a crucible, the heating induction facility and a housing. Thus, the melting vessel is not only an interchangeable crucible, but rather also comprises further important constituents of an induction furnace, such as for example the induction coil.

Preferably, the melting vessel is characterized by an open design, but during a transport it can be equipped with a temporary, improvised covering for minimizing heat losses. Thus, the melting vessel preferably comprises an opening in its upper section. Through the opening metallic material can be filled into the crucible. So also evacuation or introduction of a protective gas is possible. For treating the melt, preferably only at a treatment station the melting vessel is closed with the cover being appropriate for the treatment station. For this purpose the treatment station preferably comprises a cover being appropriate for the melting vessel. The cover may comprise connections, for example for evacuating the melting vessel or for introducing a protective gas.

The crucible is the part of the melting vessel, in which the metallic material is treated. Therefore, it is preferably manufactured from a refractory material. The refractory material is preferably selected from ceramic and/or graphite. Preferable ceramics comprise aluminum oxide and/or magnesium oxide. Such a crucible can normally be used 10 to 80 times. Preferably, the volume of the crucible is at least 200 dm³.

Preferably, the melting vessel is equipped with an outflow, for allowing pouring off of the melt after completion of the treatment at the treatment station. In an alternative embodiment the melting vessel does not comprise an outflow. Instead of that the cover of the treatment station can be equipped with an opening, in particular an outflow, for pouring off of the melt.

Preferably, the housing of the melting vessel is manufactured from metal. The preferred metal is steel. In the case of normal operation the melt does not come into contact with the housing.

Between the inner crucible and the outer wall preferably a spacing is provided for accommodating the coil and parts of the cooling system, for example lines for the cooling medium. In the spacing also further constituents of the melting vessel can be arranged, such as for example measuring devices, in particular measuring devices for temperature and pressure.

In preferable embodiments the induction coil is arranged between the inner crucible and the outer wall of the melting vessel, in particular it is coiled around the inner crucible.

The melting vessel is preferably suitable for being filled at a first station with metallic material, in particular molten metallic material, wherein this first station is referred to as filling station. For this purpose the melting vessel is preferably moved on rails into the area of the filling station, in particular the melting vessel is pulled from a towing vehicle. After the filling step the melting vessel can be moved to the treatment station. In an alternative embodiment at the treatment station the metallic material is filled into the crucible, in particular via a material lock, preferably from above. This is particularly advantageous, when metallic material has to be treated which has to be melted under vacuum. This, for example, applies to different highly alloyed steels.

Preferably, the metallic material remains in the melting vessel during several treatment steps. In contrast to prior art, namely, it is not required to transfer molten metallic material from one melting crucible into another. The use of tilting hoppers is not necessary. This makes the method according to the present invention very useful in the production of highly alloyed steels which have to be prepared under exclusion of air.

Preferably, the melting vessel comprises monitoring devices for monitoring the status of the melt. Such monitoring devices are, for example, temperature measuring instruments.

Due to the fact that the melting vessel comprises the heating facility a simpler design of the treatment station is possible. In prior art, normally, a large technical effort is required for inserting crucibles into heating facilities. According to the present invention such a difficult procedure is not required. The crucible in the melting vessel according to the present invention is only removed for the purpose of maintenance and/or for the exchange of the crucible after a series of (preferably at least ten) melting processes.

From the fact that the melting vessel already contains the heating facility for heating the melt the further advantage, namely that the heating facility can be arranged nearer to the crucible in which the melt is located, results. According to the present invention it is preferable, when the induction coil of the induction heater is arranged between the housing and the crucible of the melting vessel. Thus, also certain requirements with regard to the material of the housing are no longer important. For example, it is not required that the wall of the housing has a slit design.

In regard to the treatment station the device according to the present invention complies with the induction furnace described in EP 0 212 072 A2. In some aspects the melting vessel of the present invention corresponds to the lower part of the furnace according to the patent application cited. The significant difference is that in the cited patent application no mobile melting vessel is provided. It is rather necessary to disassemble the induction furnace for making the melting vessel accessible.

Preferably, the device for treating metallic material comprises a device for filling the melting vessel with either molten or solid metallic material (e.g. filling station). The device may comprise a material lock which can be positioned on the opening of the melting vessel. In a preferable embodiment this material lock is positioned on the cover of the treatment station. Then the cover in turn has an opening which can be closed. In this embodiment a filling station is not required, because the material is filled in directly at the treatment station.

Preferably, the treatment station is designed such that the melting vessel is lifted up from below to the treatment station. So, preferably, the cover is not lowered down onto the melting vessel or the crucible, but the melting vessel is lifted up from below to the cover together with the crucible and the heating facility. It is possible that the cover and the melting vessel are fixed to each other via a flange connection. The supply of the heating facility with electricity and the supply of the cooling system with cooling medium can then preferably be realized via a quick coupling—such as described above.

Preferably, the device according to the present invention comprises a facility for lifting up and lowering down the melting vessel at the treatment station. The lifting facility is suitable for moving the melting vessel from a first position below the cover to a second position at the treatment station, wherein this movement is preferably an upward movement, wherein in particular the cover of the treatment station is not lowered down onto the melting vessel, but the melting vessel is lifted up to the cover.

In preferable embodiments the device according to the present invention preferably comprises exactly one treatment station which is in particularly suitable for conducting all treatment steps to be conducted.

The device according to the present invention comprises a (preferably automatic) quick coupling which is suitable for connecting supply lines of the treatment station to the melting vessel so that the heating induction facility can be supplied with electricity and the cooling system can be operated. In this context “automatic” means that no manual action of a human on the quick coupling is necessary. Preferably, the connection is achieved by machine-controlled connection of the supply and acceptor modules.

Preferably, the treatment station is designed as a kind of induction furnace such as described in the European patent application EP 0 212 072 A2. Then, the melting vessel according to the present invention would more or less correspond to the lower part of the furnace. In regard to other embodiments of the treatment station, in particular in regard to the facility for tilting the melting vessel reference is made to this patent application. In this context, preferably, the following features are also contained in the present invention. The cover of the treatment station is preferably connected with the melting vessel via a flange connection. According to the present invention, preferably, the melting vessel can be tilted around a tilting axis by means of a swivel and a drive. Preferably, it goes without saying that the housing of the melting vessel is also implemented in a gas-tight manner. Preferably, the tilting drive also engages at the cover of the treatment station. Preferably, the cover of the treatment station is fixed at a furnace rack and remains at this furnace rack, when the melting vessel is uncoupled. Herewith, the mentioned patent application is incorporated by reference into this application.

Also according to the present invention is a method for treating metallic material using a device according to one of the preceding claims, comprising the steps of (in random order), coupling the mobile melting vessel to the treatment station, filling metallic material into the crucible, evacuating the melting vessel (crucible), heating the material under vacuum, optionally heating the liquid material under protective gas. optionally heating and degassing the liquid material in one step, optionally degassing by means of a gas purging piece or electromagnetic stirring, optionally further treating the metallic material in the crucible, pouring off the metallic material, optionally measuring the temperature of the liquid material, optionally withdrawing a sample of the liquid material, wherein during the filling step the metallic material is molten or solid, and during the filling step the crucible is already evacuated or it is evacuated after the filling step.

A person skilled in the art is capable of determining a suitable order of the mentioned process steps for achieving his or her respective target. In particular he or she is capable of assessing, whether it is advantageous, to fill solid metallic material into the crucible, or if this material should be melted before in a melting unit. Typically it is advantageous to fill highly alloyed steels which have to be melted under vacuum in the solid state into the crucible. Similarly, the coupling to the treatment station can be conducted either before, since the melting vessel can be cooled on the transport vehicle, or after the filling step.

Preferably, the treatment of the metallic material takes place at temperatures of 600° C. to 1700° C., particularly preferably at temperatures of 900° C. to 1600° C. and further preferably at temperatures of 1100° C. to 1550° C. and in particular of 1400° C. to 1500° C. Of course, the selected temperature depends on the kind of the metallic material to be treated. It is particularly preferable that during the process after the melting step the temperature of the metallic material is always maintained at a value of at least 20° C., further preferably at least 100° C. higher than the melting point of the metallic material. Due to the heating facility in the melting vessel such a step of maintaining the temperature at a desired level can be realized also in the case of transporting the melting vessel.

In a preferable embodiment the crucible is filled at a filling station with the metallic material which is preferably already molten at this time. Then, preferably, after the filling step the crucible is moved from the filling station to the treatment station, while the heating induction facility maintains the temperature of the content of the crucible at a value of higher than the melting point of the metallic material, however preferably at a value of at least 600° C. Then, the melting vessel is coupled to the treatment station, in particular by lifting up the melting vessel. The charging (filling) of the crucible which is conducted outside the treatment station can be conducted by means of the auxiliary cooling unit directly after the step of pouring off of the previous melt outside the treatment station, since the melting vessel can be removed by means of the quick coupling and can be cooled further.

In an alternative embodiment solid metallic material is filled into the melting vessel and during this step the melting vessel is coupled to the treatment station. The filling is preferably conducted using a material lock which can in particularly be positioned on the cover of the treatment station. Such a way of handling is recommended in particular in the case of metallic material for which melting and treating under the influence of air is disadvantageous.

Treatment steps which are conducted at the treatment station are preferably conducted under vacuum. During such steps the pressure in the melting vessel, in particular in the crucible, is preferably at most 1 mbar, further preferably 10⁻¹ mbar, more preferably at most 10⁻² mbar and in particularly at most 10⁻³ mbar. Preferably, the evacuation is realized by a vacuum pump system which is preferably a constituent of the treatment station. Preferably, the vacuum pump system is connected with the cover of the treatment station via one or more lines so that the interior of the melting vessel can be evacuated.

According to the present invention, preferably, several treatment steps are conducted at the treatment station. Preferably, at the treatment station one or more of the process steps heating, degassing, alloying, stirring, gas purging and pouring off are conducted. According to the present invention it is not required to use a separate heating apparatus and a separate degassing apparatus. It is rather possible to conduct these steps at one treatment station without the need of eliminating the vacuum in the inner crucible. Also a transport between several treatment stations is no longer necessary. Due to the fact that during several process steps the vacuum can be maintained it is effectively avoided that hydrogen, oxygen and nitrogen are introduced.

The method according to the present invention preferably comprises the steps heating, degassing, alloying, stirring, gas purging and pouring off, particularly preferably in the mentioned order. Preferably, all these steps are conducted in one single crucible. During all these steps, preferably, the cover of the treatment station remains on the melting vessel without any interruption.

A further advantage is that it is possible to treat the melt with vacuum for a substantially unlimited time. It is not necessary to move the melting vessel in a ridable manner to a heating apparatus again, as is often the case in prior art.

The melting vessel can be closed at the treatment station with a cover which is a constituent of the station. Preferably, the cover gas-tightly seals the melting vessel so that a vacuum treatment of the metallic material is possible. Thus, no large vacuum chamber is necessary, as is the case in many prior art embodiments. The cover may comprise connections for vacuum pumps so that it is not required to place the melting vessel in a vacuum chamber. Preferably, the cover is connected with the melting vessel or the crucible by coupling the melting vessel to the treatment station.

Preferably, the method comprises a treatment step which is a vacuum treatment or is conducted under vacuum. The melting vessel can be detached from the transport facility. This, for example, may be useful for pouring off the melt from the melting vessel.

Preferably, the method according to the present invention comprises preheating of the metallic material which has been introduced in the solid state to a temperature of at least 600° C. and at most 800° C. Preferably, after filling of the material into the melting vessel this preheating takes place. In preferable embodiments the temperature of the crucible is already in this range, when material is filled in.

In a preferable embodiment, after a first melting step at the treatment station further metallic material can be filled into the crucible. This filling is preferably conducted using the same material lock as is already described above.

When a melting vessel filled with molten material is transported, then according to the present invention it is preferable that the melt is not stirred during the transport. The reason for that is that the device according to the present invention and the method according to the present invention are intended for the production of high-quality steels. Such steels having acceptable quality can only be produced, when the influence of air is restricted as far as possible. Stirring of the melt, however, would result in increased temperature losses and introduction of hydrogen, nitrogen and oxygen into the melt. Normally, during the transport the melting vessel is not closed, because the cover is a constituent of the treatment station. But the melting vessel can be covered in a temporary, improvised manner for reducing heat losses.

Preferably, the crucible, the coil and the housing of the melting vessel are not separated from each other during the conduction of the method according to the present invention. Thus, these components form one unit.

The vessel of this invention holds metal in amounts of preferably 1 to 40 t, further preferably 5 to 30 t, in particular up to 10 t.

Furthermore, several melting vessels can be treated in the treatment station one after the other. This is advantageous for increasing the productivity of the method. Here it is envisaged to treat melting vessels in the treatment station in an alternating manner or in cycles, while further melting vessels, preferably at or on transport facilities, are charged or are moved to a crucible breaking out station or a crucible brick lining station. Preferably, the crucible breaking out station is provided at the end of the travel of a crucible. Preferably, the crucible brick lining station (station for providing a crucible) is intended for the preparation of the use of the crucible. Preferably, also a crucible drying station is provided. The movement of the melting vessel for these purposes may be realized by means of one or more transport facilities.

### BRIEF DESCRIPTION OF THE DRAWINGS

FIG. 1 shows a mobile melting vessel 1 according to the present invention. The melting vessel comprises wheels 2 with which it can be moved on rails. The melting vessel comprises a crucible 3 and a housing 4. The crucible serves for receiving a metallic material which can be treated in the melting vessel. The housing protects the crucible and parts of the heating facility as well as the cooling system which are arranged between the housing and the crucible. The heating facility comprises a coil 5 being arranged in the spacing. The coil is cooled by the cooling system. For this purpose also lines 6 for the coolant are arranged in the spacing between the housing and the crucible. A spout 7 is arranged in the upper section at the opening 8 of the melting vessel at the crucible so that molten material can be poured off by tilting the melting vessel.

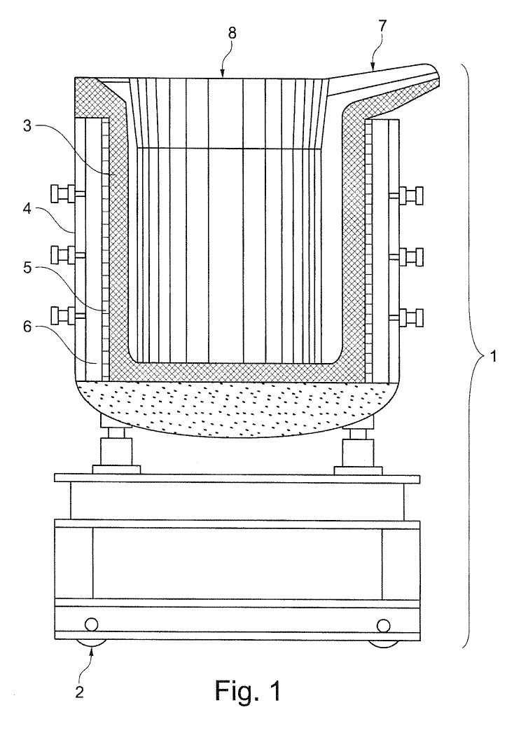

FIG. 2 shows a melting vessel 1 which is connected with the treatment station via a cover 12. The cover gas-tightly seals the melting vessel so that the interior of the melting vessel which is restricted by the crucible 3 can be evacuated or can be filled with protective gas. For this purpose the cover preferably comprises at least one connection 13. The connection can provide a connection to a vacuum pump and/or a source of protective gas. The heating facility is arranged in the melting vessel between the crucible and the housing. The media being required for the operation of the heating facility, in particular electricity and cooling medium, are provided from the treatment station in this operation condition. When the cover is connected with the melting vessel, at the same time, preferably, media connections are coupled, in particular via a quick coupling (not shown). After completion of the treatment procedure the melt can be poured off via the spout 7. Advantageously, the treatment station comprises a tilting facility which is suitable for tilting the melting vessel via a tilting axis 14.

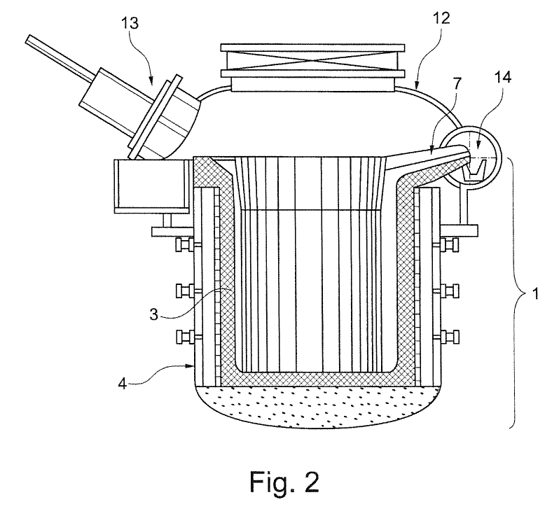

FIG. 3 shows a melting vessel such as described above together with a transport facility 15 in the form of a towing vehicle. The towing vehicle is suitable for pulling the melting vessel on rails. On the transport facility preferably a current supply 16 is arranged which via lines 17 supplies the heating facility of the melting vessel with electricity. In addition, on the transport facility parts of the cooling system 18 may be arranged. In particular, from there a supply of the lines for cooling liquid in the melting vessel can be realized via lines 19.

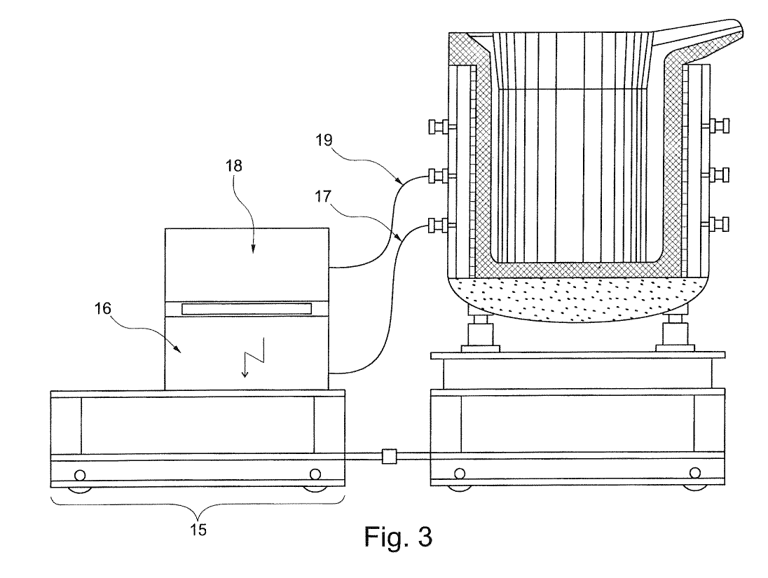

### DETAILED DESCRIPTION OF INVENTION

A description of a typical method which can be conducted with the device according to the present invention follows.

Before melting, preferably one or more of the following process steps have to be conducted:
Filling the material into the crucible under atmosphere or vacuum. Charging of solids or liquids is possible.
Then, the crucible is loaded with the main constituent of the alloy to be produced.
Then, the evacuation of the crucible and further constituents in the treatment station (e.g. melting chamber, casting chamber, gutter chamber, charging chamber) follows
Conduction of a tightness test
When the result of the tightness test is positive, switching on the heating facility and starting the melting
Continuous evacuation of the melting crucible for maintaining the reduced pressure and for extracting passing out gases

After the beginning of the melting, preferably the following process steps have to be conducted:
Melting of the material. Most often under vacuum, but may also be conducted partly under an inert gas atmosphere
For non-standard grade steels and super alloys air exclusion has to be guaranteed
For standard grade steels with normal quality and copper alloys with low requirements the melting may also be conducted under air

After melting of the material, preferably one or more of the following process steps have to be conducted:
Additional charging of material, addition of alloy additives and/or vacuum treatment (degassing under vacuum and by stirring of the liquid melt)
Purification and homogenization of the melt
Removal of elements by degassing (nitrogen, hydrogen, volatile trace elements) or by chemical reactions (oxygen, carbon)

After melting of the material and before the pouring off step, preferably one or more of the following process steps have to be conducted:
Withdrawing of a sample, temperature measurement
Conducted under vacuum: sampling device or thermocouple are preferably introduced from above into the melting vessel via the charging chamber
Repeating of additional charging, vacuum treating, degassing, refining, withdrawing of a sample and/or measuring the temperature until the desired purity and alloy composition are obtained
The melt can be treated nearly without any time limit
Addition of volatile alloy additives (volatile alloy additives such as for example magnesium evaporate in vacuum, therefore the addition thereof has to be conducted a short time before the pouring off step)
Last measurement of the temperature and withdrawal of a sample
Pouring off of the melt into molds
Purification of the chambers and the melting crucible, if necessary, then start of a new process.

### LIST OF REFERENCE SIGNS

(1) melting vessel
(2) wheels
(3) crucible
(4) housing
(5) coil
(6) lines
(7) spout
(8) opening of the melting vessel
(9) not used
(10) not used
(11) not used
(12) cover
(13) connection
(14) tilting axis
(15) transport facility
(16) current supply
(17) lines
(18) cooling system
(19) lines

What is claimed is:

1. A device for treating metallic material, comprising:
a mobile melting vessel and at least one treatment station, wherein
the mobile melting vessel comprises a crucible, a heating induction facility with a coil and a housing,
the treatment station comprises a cover which is suitable for gas-tightly closing the crucible, and
the mobile melting vessel can be separated from the treatment station and can be moved in a ridable manner independently from the treatment station, wherein
the device comprises a quick-coupling system so that supply lines of the treatment station can be connected to the mobile melting vessel for cooling the heating induction facility and/or for supplying it with electricity,
a transport facility is provided which is suitable for moving the melting vessel out of the area of the treatment station, and
means at or in the transport facility and/or the mobile melting vessel are provided for cooling the heating induction facility during the movement of the melting vessel and/or for supplying it with electricity.

2. The device according to claim 1, wherein the transport facility and/or the melting vessel comprise a cooling unit and/or a power generator for cooling the coil during the transport and/or for supplying it with electricity.

3. The device according to claim 1, wherein the transport facility is a towing vehicle.

4. The device according to claim 1, wherein the heating induction facility, at least after coupling to the treatment station, is suitable for maintaining metallic material which is located in the crucible in a molten state and/or melting it.

5. The device according to claim 1, wherein the treatment station comprises a tilting facility for pouring off a melt of the metallic material.

6. The device according to claim 1, wherein in the case of leaving the treatment station the quick coupling automatically uncouples the melting vessel from the main supply and the quick coupling automatically couples the melting vessel to the transport device.

7. The device according to claim 1, wherein in the case of leaving the transport device the quick coupling automatically uncouples the melting vessel from the auxiliary supply and the quick coupling automatically couples the melting vessel to the treatment station.

8. The device according to claims 6, wherein in the case of locking the quick coupling the coolant supply is automatically started and in the case of releasing the quick coupling the coolant supply is automatically stopped.

9. A method for treating metallic material using a device according to claim 1 comprising the steps of (in random order),
coupling the mobile melting vessel to the treatment station,
filling metallic material into the crucible,
evacuating the crucible,
treating the metallic material in the crucible under the influence of heat and vacuum, and
pouring off the metallic material,
wherein
during the filling step the metallic material is molten or solid, and
during the filling step the crucible is already evacuated or after the filling step it is evacuated.

10. The method according to claim 9, wherein the treatment of the metallic material is conducted at temperatures of 600° C. to 1700° C.

11. The method according to claim 9, wherein the crucible is filled with the metallic material at a filling station and only after this filling step and a step of coupling to the treatment station it is evacuated.

12. The method according to claim 11, wherein after the filling step the crucible is moved from the filling station to the treatment station, wherein during this step the heating induction facility maintains the content of the crucible at a temperature of at least 600° C.

13. The method according to claim 11, wherein the crucible after filling in the liquid material is moved from the filling station to the treatment station, wherein during this step the melt is maintained at a temperature which is at least 10° C. higher than its melting point.

14. The method according to claim 9, wherein the induction coil during the treatment step in the treatment station is cooled with an amount of a cooling medium which is at least the double amount of the cooling medium being required during the transport on the transport device for cooling the induction coil.

15. The method according to claim 9, wherein the metallic material comprises iron, cobalt, chromium, copper and/or nickel in a proportion of higher than 50% by weight.

16. The method according to claim 9, wherein in the treatment station the material is treated at pressures of lower than 10⁻¹ mbar and simultaneous heating is conducted.

17. The method according to claim 9 for the use of the device comprising more than one melting vessel, which can be treated one after the other in the same treatment station.

18. The method according to claim 17, wherein one melting vessel is loaded, while another one is located in the treatment station.

19. The device according to claim 2, wherein the transport facility is a towing vehicle.
